(19) United States
(12) Patent Application Publication
(10) Pub. No.: US 2026/0337024 A1
(43) Pub. Date: Oct. 29, 2026

(54) A process for producing carbon impurity reduced/carbon impurity free lithium sulfide, said carbon impurity reduced/carbon impurity free lithium sulfide, and its use for producing solid-state electrolytes and solid-state batteries

(71) Applicant: Albemarle Germany GmbH, Frankfurt am Main (DE)

(72) Inventors: Thomas JANSEN, Goslar (DE); Katrin Wessels, Hannover (DE); Alexander Hubner, Langelsheim (DE); Ulrich Wetelmann, Friedrichsdorf (DE); Anja Weiland, Langelsheim (DE); Tanita Frommer, Seesen (DE); Raphael Steinbach, Salzgitter (DE)

(21) Appl. No.: 19/486,140

(22) PCT Filed: May 24, 2024
(86) PCT No.: PCT/EP2024/064417

§ 371 Date: Nov. 20, 2025

(30) Foreign Application Priority Data
May 30, 2023 (DE) 10 2023 114 082.5

(51) Int. Cl. C01B 17/36; H01M 10/0525; H01M 10/0562; H01M 10/058

(52) U.S. Cl. CPC C01B 17/36; H01M 10/0525; H01M 10/0562; C01P 2002/72; C01P 2006/40; C01P 2006/80; H01M 10/058; H01M 2300/0068

(57) ABSTRACT

The invention relates to a process for the production of lithium sulfide reduced in carbon impurity or free from carbon impurity, in which lithium sulfate and optionally lithium sulfit, lithium disulfate and/or other lithium sulfur oxides, and carbon impurity containing lithium sulfide are treated with hydrogen gas at temperautres in range from 300 to 600 °C. The invention further relates to a lithium sulfide producible in this manner, the carbon impurity content of which is less than 2.0% by weight, based on the weight of the lithium sulfide. This lithium sulfide is used for the production of battery components, preferably solid electrolytes, and solid-state batteries.

The invention relates to a method for the preparation of lithium sulfide reduced in carbon impurity or free from carbon impurity or for purifying lithium sulfide to efficiently remove or avoid impurities such as residual carbon or other carbon-containing impurities and lithium sulfate from/in lithium sulfide, respecitvely, used for electronic and electrical materials.

Furthermore, the invention relates to said purified lithium sulfide, a solid electrolyte for a rechargeable lithium battery and a solid-state battery containing such a solid electrolyte.

Lithium sulfide is currently attracting much interest as a raw material for the preparation of solid electrolytes for solid-state batteries (Lee et. al, Acc. Chem. Res, 54, 3390, 2021). Solid-state batteries offer higher energy densities and faster charging capabilities compared to the state of the art. In addition, solid-state batteries are generally considered safer because they do not contain highly flammable organic solvents (Lee et. al, Acc. Chem. Res, 54, 3390, 2021). In addition, lithium sulfide finds application as a cathode material in lithium/sulfur batteries (EP 2 896 085A1 ). Lithium/sulfur batteries also have a significantly higher energy density compared to conventional lithium-ion batteries and are thus of interest for potential application in the field of electromobility.

If the purity level of a raw material, such as a solid electrolyte used in a rechargeable battery, is low, component aging can accelerate. Therefore, the purity level of the solid electrolyte or other raw material must be high (EP 1 681 263 A1). In particular, graphitized carbon in lithium sulfide as a raw material for solid electrolytes must be avoided as completely as possible, since it can lead to undesirable electronic conductivity in the solid electrolyte (Nikodimos et. al, Energy Environ. Sci., 2022, 15, 991).

Processes for the preparation of lithium sulfide, by which lithium sulfide can be prepared by simple means, are sufficiently known (e.g., EP 0 802 575A1 ).

One known process describes the production of lithium sulfide in a carbothermic reduction at high temperatures from lithium sulfate and carbon (CN 106229487 A). It is basically an economical and simple process, since the production steps can also be carried out continuously. In addition, the raw materials lithium sulfate and carbon are readily available. However, carbothermal reduction often leads to significant impurities in the lithium sulfide. These are usually unreacted reactants such as carbon or lithium sulfate. In addition, lithium sulfite, lithium carbonate, and/or lithium oxide may be formed.

Another process describes the reduction of lithium sulfate with hydrogen to lithium sulfide at high temperatures in the melt at about 1150 °C (U.S. Pat. No. 2,840,455). Such a melt solidifies after cooling and does not result in the desired powdered lithium sulfide. This circumstance makes a reduction with hydrogen to lithium sulfide economically unattractive.

If lithium sulfide is produced by the carbothermic method, the typical contamination with residual carbon causes the lithium sulfide to produce additional undesirable electronic conductivity as a raw material for a solid electrolyte for a rechargeable lithium battery, and thus the desired battery performance and long-term stability cannot be achieved.

It is an object of the invention to solve this problem by providing a process for producing lithium sulfide reduced in carbon impurity or free from carbon impurity, in which a content of carbon and/or carbonaceous impurities contained in the lithium sulfide constituting a raw material for a solid electrolyte of a rechargeable lithium battery is minimized or completely avoided.

Another object of the invention is to provide such lithium sulfide reduced in carbon impurity or free of carbon impurity, a solid electrolyte, in particular for a rechargeable lithium ion battery, using such lithium sulfide, and a solid battery in which the carbon impurities are minimal or absent.

These objects are solved by a process for producing lithium sulfide reduced in carbon impurity or free from carbon impurity, characterized in that lithium sulfide containing lithium sulfate and optionally lithium sulfit, lithium disulfate and/or other lithium sulfur oxides, and carbon impurity is treated with hydrogen gas at temperatures in the range of 300 to 600 °C.

The hydrogen gas treated lithium sulfide preferably is produced by reaction of lithium sulfate with a carbon source, preferably carbon black, wherein the lithium sulfate is added in stoichiomentric excess.

Unreacted lithium sulfate, optionally produced lithium sulfite, lithium disulfate or other lithium sulfur oxides are reduced to lithium sulfide subsequently with hydrogen gas at tempratures in the range of 300 to 600 °C.

The invention therefore provides lithium sulfide that is low in or free of carbon impurities, which is produced by this process according to the invention.

Furthermore, the invention relates to the use of such a lithium sulfide for the production of battery components, preferably in solid electrolytes.

Accordingly, the invention also relates to a process for purifying lithium sulfide that can efficiently remove impurities such as lithium sulfate, lithium sulfite, lithium disulfatre or other lithium sulfur oxides and carbonaceous impurities from lithium sulfide.

Furthermore, the invention relates to such a solid electrolyte for a rechargeable lithium ion battery and a corresponding solid battery.

Surprisingly, it has been shown according to the invention that carbon impurities, e.g. carbon or carbon-containing, inorganic or organic compounds in the lithium sulfide can be minimized or even completely avoided by using a stoiciometric excess of lithium sulfate and by a post-treatment with hydrogen at temperatures in the range of 300 to 600 °C, without the disadvantages expected in the prior art. In particular it is possible to completely avoid the formation of a melt, which is typically observed when directly reducing lithium sulfate with hydrogen.

The residual carbon/residual carbon compound content of the lithium sulfide treated with hydrogen gas according to the invention is less than 2.0% by weight, preferably less than 1.0% by weight, more preferred less than 0.5% by weight, in particular less than 0.3% by weight, and still more preferred less than 0.25% by weight. Ideally it is less than 0.05% by weight, or even is 0% by weight.

The lithium sulfide used for the production of carbon impurity reduced/carbon impurity free lithium sulfide according to the invention is preferably produced carbothermal by first reducing a stoiciometric excess of lithium sulfate with a carbon source, preferably carbon black, to lithium sulfide.

Carbon sources or carbon impurities can include crystalline and amorphous forms of carbon. Crystalline forms include graphite, graphite-like carbon (including carbon black or activated carbon), graphene, fullerenes, or carbon nanotubes. Carbonaceous impurities include both inorganic carbon compounds (e.g., carbides) and organic carbon compounds.

Preferably, the lithium sulfate used is high-purity, anhydrous lithium sulfate obtained from lithium-containing minerals such as spodumene, brines or recycled lithium ion batteries. In particular, carbon black with a specific surface area of 1 to 1000 m² /g, preferably 100 to 200 m² /g, is used as the carbon source.

In order to produce a lithium sulfate/carbon mixture that is as homogeneous as possible, the two components are preferably mixed in a zirconium dioxide-lined plane ball mill. For better mixing, zirconium dioxide balls can also be added to the grinding bowl. The grinding time is typically between 1 and 24 hours, preferably 1 to 3 hours.

The lithium sulfate/carbon mixture is typically reacted in the temperature range from 650 to 900 °C under inert conditions, preferably in the temperature range from 750 to 850 °C. For the purposes of the invention, inert conditions are understood to mean working under inert gas to the exclusion of air and humidity. For this purpose, the lithium sulfate/carbon mixture is weighed out, mixed as homogeneously as possible, filled into a temperature-resistant crucible, e.g. aluminum oxide, boron nitride or glassy carbon, and reacted according to the following reaction equation:

(1+x) Li₂SO₄+2 C→Li₂S+x Li₂SO₄+2 CO₂

where x represents excess lithium sulfate (x=0.0005 to 1).

The lithium sulfate/carbon molar ratio is therefore in the range of 1.0005:2 to 2:2, (corresponding to x=0.0005 to 1), preferably, based on lithium sulfate, a stoichiometric excess of lithium sulfate in the range of 0.05 to 10 mole % is present, even more preferably a stoichiometric excess of lithium sulfate in the range of 0.1 to 5 mole %.

This reaction results in a lithium sulfide, which is carbon reduced or carbon free. Excess lithium sulfate has to be removed in the post-treament step.

The problem is solved by the step of purifying the lithium sulfide according to the invention as follows:

According to the invention, the contaminated lithium sulfide is treated with a hydrogen-containing gas mixture, where the hydrogen content can be from 1 to 100% by volume, preferably from 5 to 10% by volume, the remainder of the hydrogen gas being nitrogen and/or argon.

The treatment with the hydrogen gas according to the invention is carried out in a temperature range of 300 to 600 °C, preferably 400 to 575 °C, preferred 450 to 550 °C, more preferred 475 to 525 °C, still more preferred 490 to 510 °C, in particular 495 to 505 °C.

The treatment time with the hydrogen gas according to the invention is preferably 1 to 10 hours, in particular 1 to 8 hours, preferred 1 to 5 hours. For this purpose, commercially available “forming gases”, i.e. mixtures of hydrogen and nitrogen and/or argon, can be used, for example.

According to the invention, the lithium sulfide contaminated with lithium sulfate can be treated for example according to the equation below, at 300 to 600 °C with forming gas containing 5% hydrogen by volume for 1 to 10 hours. The amount of H₂ required is at least four times the stoichiometric amount of the residual lithium sulfate portion:

Li₂S+y Li₂SO₄+4 y H₂→1+y Li₂S+4 y H₂O

According to the reaction equation, the remaining lithium sulfate is removed from the lithium sulfide in this reaction by the formation of gaseous water. What remains is purified white crystalline lithium sulfide.

The exemplary isolated materials (see Examples 1 and 2) show lines in the X-ray diffraction pattern only for the desired LizS (content >99 wt %), the carbon content is <0.06 wt %.

According to the invention, the lithium sulfide is preferably overflowed with a stream of the hydrogen gas during the treatment.

### MEASUREMENT METHODS

The phase purity of the samples was checked using a Bruker D2-Phaser X-ray powder diffractometer in Bragg-Brentano geometry. An X-ray tube with Cu-Kα radiation (λ=0.15418 nm) was used as the radiation source. Quantification of lithium sulfate was made by use of the Rietveld method.

Quantification of the elemental proportions of lithium, sulfur, and carbon in lithium sulfide was performed using the elemental analysis unit of the Keyence VHX-7000 digital microscope. Using a UV laser (λ=250 nm; P=0.01 mW), a small amount of sample (<1 mg) is vaporized and atomized. The characteristic atomic emission lines are detected and used for quantification.

The advantages of the process according to the invention compared to the state of the art are thus:
the direct purification of a lithium sulfide obtained by carbothermal reduction and the resulting availability of the low-carbon/carbon-free lithium sulfide for the production of solid-state electrolytes;
the use of commercially readily available starting materials;
the avoidance of working with air and moisture sensitive solids such as Li-metal, lithium hydride, lithium alkyls, lithium aryls or lithium amides;
avoidance of working with toxic sulfur sources, such as hydrogen sulfide or carbon disulfide;
direct use of lithium sulfate from lithium ion battery recycling without the energy-intensive conversion to, for example, lithium hydroxide;
the avoidance of organic solvents (e.g. THF) for further purification of the lithium sulfide by a further process step.

All operations are preferably performed in an Ar-filled glove box.

### EXAMPLES

The measurement methods described above were used in the following Examples to determine the product properties.

### Example 1

4.62 g (42 mmol) of lithium sulfate (99.0%, Albemarle Germany GmbH), anhydrous, were weighed in with 0.96 g (80 mmol) of carbon black having a specific surface area of about 176 m²/g (Cabot Vulcan P Fluffy) and then intimately triturated in an agate mortar. The lithium sulfate/carbon mixture was then transferred to a Fritsch zirconium dioxide lined grinding bowl. 12 grinding balls with a diameter of 10 mm were added. The grinding bowl was then hermetically sealed under inert gas and placed in a “Pulverisette 7” planetary ball mill from Fritsch. The mixture was ground for 2 hours at 600 rpm. After the grinding process, the zirconium dioxide balls were sieved off. The homogenized lithium sulfate/carbon mixture was then transferred to a corundum annealing box. The mixture was converted to lithium sulfide for 3.3 hours at 850 °C under a stream of nitrogen. The lithium sulfide, still contaminated with lithium sulfate, was then post-treated by switching to forming gas containing hydrogen by volume for 6 hours at 500 °C. After cooling, it was purged with nitrogen. The phase purity of purified lithium sulfide was checked by X-ray diffraction. The lithium sulfide obtained was a microcrystalline powder, which shows no sintering or other agglomerates.

### Content Li₂S: >99%

Content Li₂SO₄: <1.0%
Residual carbon content: <0.06%
Color Li₂S: Pure white

### Example 2

4.84 g (44 mmol) of lithium sulfate (99.0%, Albemarle Germany GmbH), anhydrous, were weighed in with 0.96 g (80 mmol) of carbon black having a specific surface area of about 176 m²/g (Cabot Vulcan P Fluffy) and then intimately triturated in an agate mortar. The lithium sulfate/carbon mixture was then transferred to a Fritsch zirconium dioxide lined grinding bowl. 12 grinding balls with a diameter of 10 mm were added. The grinding bowl was then hermetically sealed under inert gas and placed in a “Pulverisette 7” planetary ball mill from Fritsch. The mixture was ground for 20 hours at 600 rpm. After the grinding process, the zirconium dioxide balls were sieved off. The homogenized lithium sulfate/carbon mixture was then transferred to a corundum annealing box. The mixture was converted to lithium sulfide for 8 hours at 800 °C under a stream of nitrogen. The lithium sulfide, still contaminated with lithium sulfate, was then post-treated by switching to forming gas containing 5% hydrogen by volume for 8 hours at 525 °C. After cooling, it was purged with nitrogen. The phase purity was checked by X-ray diffraction. The lithium sulfide obtained was a microcrystalline powder, which shows no sintering or other agglomerates.
Content Li₂S: >99%
Content Li₂SO₄: <1.0%
Residual carbon content: <0.06%
Color Li₂S: Pure white

### Comparative Example 1: Reaction Without Excess of Lithium Sulfate

4.4 g (40 mmol) of lithium sulfate (99.0%, Albemarle Germany GmbH), anhydrous, were weighed in with 0.96 g (80 mmol) of carbon black having a specific surface area of about 176 m²/g (Cabot Vulcan P Fluffy) and then intimately triturated in an agate mortar. The lithium sulfate/carbon mixture was then transferred to a Fritsch zirconium dioxide lined grinding bowl. 12 grinding balls with a diameter of 10 mm were added. The grinding bowl was then hermetically sealed under inert gas and placed in a “Pulverisette 7” planetary ball mill from Fritsch. The mixture was ground for 2 hours at 600 rpm. After the grinding process, the zirconium dioxide balls were sieved off. The homogenized lithium sulfate/carbon mixture was then transferred to a corundum annealing box. The mixture was converted to lithium sulfide for 3.3 hours at 850 °C under a stream of nitrogen. The lithium sulfide, still contaminated, was then post-treated by switching to forming gas containing 5% hydrogen by volume for 8 hours at 525 °C. After cooling, it was purged with nitrogen. The phase purity was checked by X-ray diffraction. The lithium sulfide obtained was a microcrystalline powder, which shows no sintering or other agglomerates.
Content Li₂S: about 95%
Content Li₂SO₄: not detectable
Residual carbon content: about 5%
Color Li₂S: Pearl dark gray

### Comparative Example 2: Reaction With Excess of Lithium Sulfate and Without H2 Post-Treatment

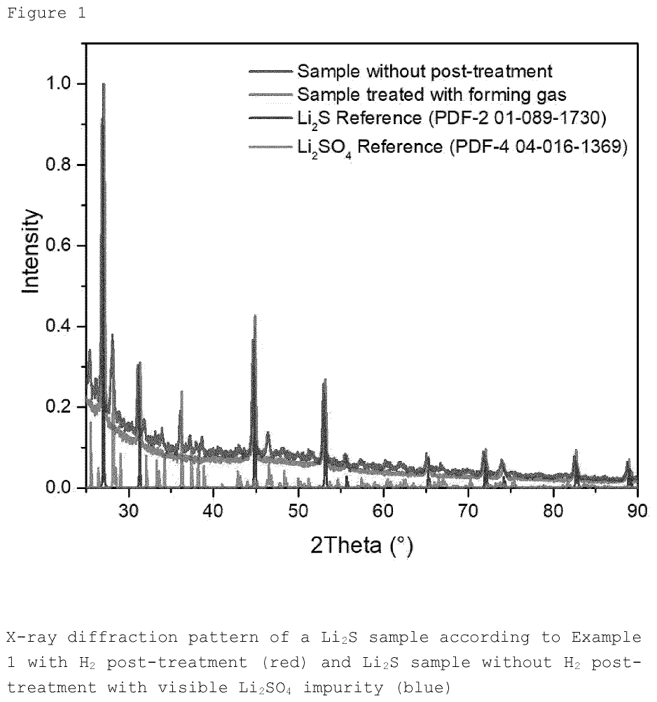

4.84 g (44 mmol) of lithium sulfate (99.0%, Albemarle Germany GmbH), anhydrous, and 0.96 g (80 mmol) of carbon black having a specific surface area of about 176 m²/g (Cabot Vulcan P Fluffy) were weighed in and then intimately triturated in an agate mortar. The lithium sulfate/carbon mixture was then transferred to a Fritsch zirconium dioxide lined grinding bowl. 12 grinding balls with a diameter of 10 mm were added. The grinding bowl was then hermetically sealed under inert gas and placed in a “Pulverisette 7” planetary ball mill from Fritsch. The mixture was ground for 2 hours at 600 rpm. After the grinding process, the zirconium dioxide balls were sieved off. The homogenized lithium sulfate/carbon mixture was then transferred to corundum annealing box. The mixture was converted to lithium sulfide for 8 hours at 850 °C under a stream of nitrogen. The x-ray diffraction pattern in FIG. 1 shows the comparison of Example 1 and Comparative Example 2.
Content Li₂S: 97%
Content Li₂SO₄: 3 %
Residual carbon content: <0.06%
Color LizS: Pure white

### Example 3

Preparation of the solid state electrolyte Li PS5Cl 2.140 g (46.57 mmol) of the lithium sulfide prepared in Example 1, 2.070 g (9.312 mmol) of phosphorous (V) pentasulfide (99%, Sigma Aldrich) and 0.790 g (18.6 mmol) of lithium chloride (Battery Grade, Albemarle Germany GmbH) were weighed in and then triturated intimately. The mixture was then transferred to a Fritsch zirconium dioxide lined grinding bowl. 12 grinding balls with a diameter of 10 mm were added. The grinding bowl was then hermetically sealed under inert gas and placed in a “Pulverisette 7” planetary ball mill from Fritsch. The mixture was ground at 600 rpm for 20 hours. After the grinding process, the zirconium dioxide balls were removed. The homogenized mixture was then transferred to a metal cylinder and sealed with a screw cap. After 48 hours at 370 °C in a chamber furnace, the conversion to the solid state electrolyte Li₆PS₅Cl was completed. The phase purity of the solid state electrolyte was checked by X-ray powder diffraction.

1. A process for the preparation of lithium sulfide reduced in carbon impurity or free from carbon impurity, characterized in that lithium sulfide containing lithium sulfate and optionally lithium sulfite, lithium disulfate and/or other lithium sulfur oxides is treated with hydrogen gas in a temperature range of 300 to 600 °C.

2. The process according to claim 1, characterized in that the lithium sulfide to be treated with the hydrogen gas is prepared by reaction of lithium sulfate with a carbon source, preferably carbon black, wherein the lithium sulfate is added in stoiciometric excess.

3. The process according to claim 2, characterized in that the molar lithium sulfate/carbon ratio being in the range 1,0005 to 2:2, wherein preferably stoichiometric excess of lithium sulfate in the range of 0.05 to 10 mole %, even more preferred in the range of 0.1 to 5 mole %, based on lithium sulfate, is used.

4. The process according to any one of claims 1 to 3, characterized in that the hydrogen gas is a forming gas, wherein the content of the hydrogen is 1 to 100% by volume, preferably 5 to 10% by volume, wherein the remainder of the hydrogen gas can be nitrogen and/or argon.

5. The process according to any one of claims 1 to 4, characterized in that the treatment with the hydrogen is carried out at 450 to 550 °C, particularly preferred at 500 °C.

6. The process according to any one of claims 1 to 5, characterized in that the carbon impurity content of the lithium sulfide, based on the weight of the treated lithium sulfide, is less than 2.0% by weight, preferably less than 1.0% by weight, more preferred less than 0.5% by weight, in particular less than 0.3% by weight, still more preferred less than 0.25% by weight, in particular less than 0.05% by weight, or even is 0% by weight.

7. The process according to any one of claims 1 to 6, characterized in that the treatment with the hydrogen gas is carried out at 400 to 575 °C, preferably 450 to 550 °C, preferred 475 to 525 °C, more preferred 490 to 510 °C, still more preferred 495 to 505 °C.

8. The process according to any one of the preceding claims, characterized in that the treatment time with the hydrogen gas is 1 to 10 hours, preferably 1 to 8 hours, in particular 1 to 5 hours.

9. Lithium sulfide producible by the process as defined in any one of claims 1 to 8.

10. Use of carbon reduced/carbon free lithium sulfide as defined in claim 9 for the production of battery components, preferably in solid electrolytes.

11. Solid electrolyte, in particular for a rechargeable lithium ion battery, comprising lithium sulfide as defined in claim 9.

12. Solid-state battery comprising a solid electrolyte as defined in claim 11.
